(19) United States
(12) Patent Application Publication
(10) Pub. No.: US 2002/0067828 A1
(43) Pub. Date: Jun. 6, 2002

(54) Copy protected document

(76) Inventors: Michael L. Sparks, Parsons, KS (US); Steven L. Meyer, Parsons, KS (US)

Correspondence Address: PAUL M. DENK, 763 South New Ballas Rd., St. Louis, MO, 63141, US

(21) Appl. No.: 09/953,628

(22) Filed: Sep. 17, 2001

Related U.S. Application Data
(60) Provisional application No. 60/233,750, filed on Sep. 19, 2000.

(51) Int. Cl. G09C 5/00

(52) U.S. Cl. 380/54

(57) ABSTRACT

A copy protected document is disclosed which comprises a document having a surface for receiving printed images, a first image which indicates that a copy of the document has been made, the first image comprising a series of concentric circles radiating out from a central point, and a second image which hides the first image.

### BACKGROUND OF THE INVENTION

This invention relates to a copy protected document and more particularly to a copy protected document which when replicated by photocopying or any scanning-type copying device will indicate that the document is a copy.

Secured documents and negotiable instruments are easily copied or reproduced for counterfeiting purposes with the use of a black and white or color copier. Additionally, with the introduction of desk top publishing software and in combination with hardware such a personal computers and scanners, it is relatively easy to reproduce high quality copies of documents. The sophistication of these copying methods is such that is it very difficult to distinguish original documents from the reproductions. Numerous attempts have been made at trying to prevent copies from being made of original documents. Many techniques have been developed to prevent reproduction of security documents such as checks, bank notes, paper currency, stock certificates, passports, and licenses. One technique is to hide a warning message within the document that reappears upon a reproduced document. This hidden message is invisible or nearly invisible to an observer of the original document. However, upon a copy being made of the original document, the copy will visibly show thereon a warning message, such as the words VOID, COPY, UNAUTHORIZED, or DUPLICATE. An example of this technique is the use of the combination of a single tone warning phrase and a single tone background pattern. Tone is used to mean the visual effect produced by solid ink coverage or by half-tone dots, bars, marks, or lines which cover a portion of the printed area of a document. These warning phrases or patterns typically have a frequency that is measured in dots, lines, or marks per inch. Half-tone dots, bars, marks, or lines may be more or less uniformly distributed over an area to produce the visual effect.

Other examples include using a background and a warning phrase, which are each made up of half-tone elements of two pairs of element sizes. For example, the background may be made with about 50% of 130 lines per inch and 0.005 inch diameter elements such as dots, and the balance of the 130 lines per inch having 0.006 inch diameter dots. The warning message may consist of about 50% of the elements being 65 lines per inch with 0.010 inch diameter dots and the remainder of the 65 lines per inch having 0.012 inch diameter dots.

These methods have been, for the most part, successful in protecting documents from being copied. It has been found that the copying protection of these documents may be avoided by the simple adjusting of the settings for sharpness and darkness on a copier. Additionally, some documents have had their copying protection defeated by copying the document at different angles. By adjusting the angle at which the copy is placed on a copier, it is possible to produce a copy in which the warning is not visible. Therefore, it is desirable and advantageous to provide a copy protected document which is not susceptible to overriding its copy protected status by copying the document at different angles.

### SUMMARY OF THE INVENTION

In one form of the present invention, a copy protected document comprises a document having a surface for receiving printed images, a first image which indicates that a copy of the document has been made, the first image comprising a series of concentric circles radiating out from a central point, and a second image which hides the first image.

In another form of the present invention, a copy protected document comprises a document having a surface for receiving printed images, a series of first images which each indicate that a copy of the document has been made, each of the first images comprising a series of concentric circles radiating out from a central point, and a second image which hides the series of first images.

In yet another form of the present invention, a method of making a copy protected document which has a surface for receiving printed images is disclosed. The method comprises the steps of printing a first image on the surface of the document, the first image comprising a series of concentric circles radiating out from a central point and which indicates that a copy of the document has been made, and printing a second image which hides the first image.

In light of the foregoing comments, it will be recognized that a principal object of the present invention is to provide an improved copy protected document which protects against counterfeit copies being made of the original document.

Another object of the present invention is to provide a copy protected document which is of simple construction and design and which can be easily employed with highly reliable results.

A further object of the present invention is to provide a copy protected document which has a hidden image or message printed thereon which is invisible until copied and will appear independent of the angle at which the document is copied.

A still further object of the present invention is to provide a copy protected document which prevents against copying by adjusting the settings on a copier or against copying by using a desk top publishing system.

These and other objects and advantages of the present invention will become apparent after considering the following detailed specification in conjunction with the accompanying drawings wherein:

### BRIEF DESCRIPTION OF THE DRAWINGS

FIG. 1 is an illustration of a preferred embodiment of a copy protected document constructed according to the present invention;

FIG. 2 is an illustration of a copy of the copy protected document shown in FIG. 1 which is obtained after being copied by use of a copier; and

FIG. 3 is an illustration of a pattern which is used to be hidden within the copy protected document constructed according to the present invention.

### DETAILED DESCRIPTION OF THE PREFERRED EMBODIMENTS

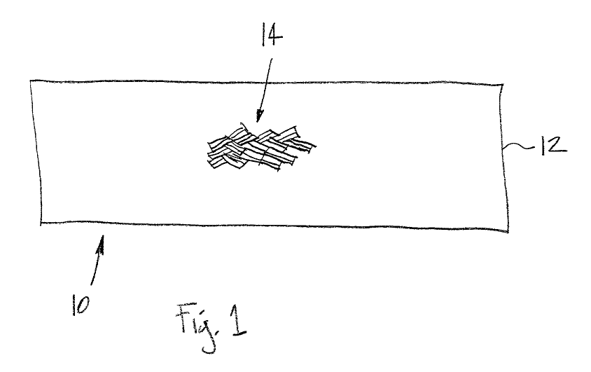

Referring now to the drawings, wherein like numbers refer to like items, number 10 identifies a preferred embodiment of a copy protected document 10 constructed according to the present invention. With reference now to FIG. 1, the copy protected document 10 is shown as a blank check 12 which does not have any printed information on it yet, such as customer information, bank name, or check number. The check 12 is rectangular in shape and has printed thereon a subdued printed design or pattern 14, such as a basket weave type pattern, which consists of various dots, lines, or combination of dots and lines. The printed pattern 14 may be printed by using various well-known methods, such as intaglio, gravure, or rotogravure. Embedded or hidden within the pattern 14 is an image (not shown) which when copied will appear on the copy of the check 12. The check 12 is shown as would be seen by an observer. Although a check 12 is shown in FIG. 1, it should be appreciated that other security type documents or other printed documents which need protection from copying could be used.

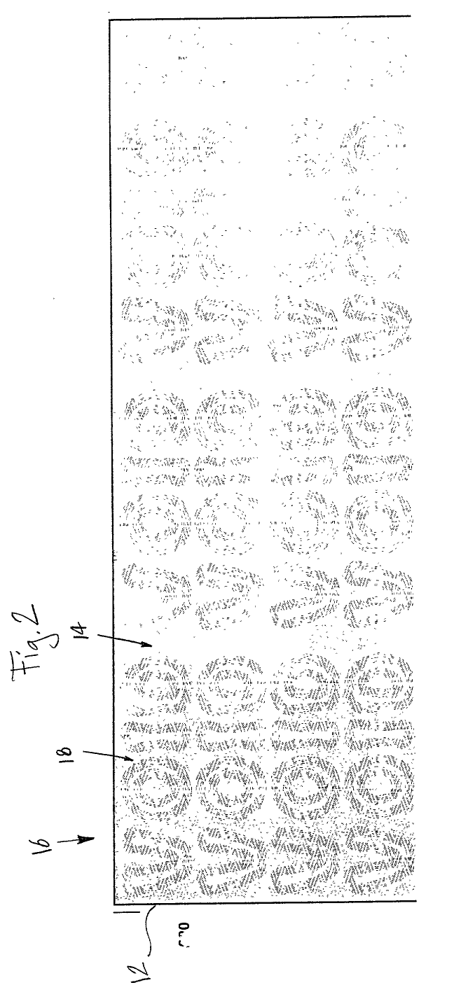

Referring now to FIG. 2, a photocopy 16 of the check 12 is illustrated. The photocopy 16 is the result of an attempt to copy the check 12 by use of, for example, a copier machine. The photocopy 16 shows an image 18, such as the words VOID, which was not visible on the original document or check 12. Additionally, a portion of the pattern 14 is still visible on the photocopy 16 in the area where the image 18 does not show or interfere. Due to the appearance of the image 18. the ability to counterfeit or copy the original check 12 is eliminated.

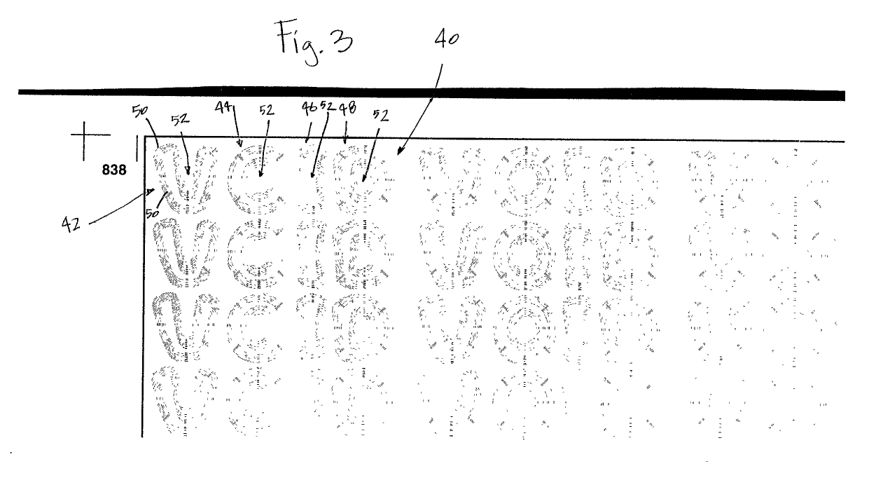

FIG. 3 shows a pattern 40 that is used to form the image 18. The pattern 40 is formed by constructing each letter or character, such as the letter V 42, the letter O 44, the letter I 46, and the letter D 48, from concentric circular lines 50 that radiate out from a central point 52. The design of the circular lines 50 is a rule weight of 0.1 point. The circular lines 50 increase in size at a rate of 0.02 inches per circle. The density of a screen is approximately 15% that these circles can be hid. When photocopied at any angle, the image 18 will be distinguishable.

The process of creating the circular lines 50 is accomplished using graphic arts or typesetting electronic software. Each character, such as the letter V 42, of the image 18 is treated as a separate logo or piece of artwork. Using “outline and fill” commands, the area of each character 42, 44, 46, or 48, is filled with the concentric circular lines 50 that radiate from the central point 52. The pattern 14 or background or second image consists of dots, lines, or a combination of dots and lines, and the density of these elements is adjusted so that the complete information including the hidden image 18 has the same visual appearance when viewed by the unaided eye. However, when photocopied, the circular lines 50 create an interference on the copier or scanner. The reproduction process magnifies this interference which causes the pattern 18 to be prominent on the copy 16. Because the circular lines 50 encompass all angles, it does not matter at what angle the document is copied and the image 18 will appear on the copy 16.

The basic method of the present invention teaches the inclusion of circular lines radiating outwardly which are embodied and integrally formed into art, pictures, or other forms of images in an original document. The circular grid lines are formed so as to differentiate from the linear grids employed by the scanning mechanisms of the machines used to replicate these black and white or colored documents. After the original documents has been created any attempt at imitation or reproduction by use of a scanning type copier will result in the generation of interference patterns which are readily discernible from the original document. The copied document is not an exact duplicate of the original document because a hidden image or message will now appear on the copied document. In this manner, duplication or counterfeiting of documents is prevented and any attempt at trying to manipulate the angle at which the document is copied will also result in the hidden message appearing.

As can be appreciated, it should be noted that other words or images may be incorporated within the copy protected document of the present invention. Any word, image, object, symbol, or device which is hidden until a copy is made is suitable for preventing copying of an original document. For example, although the word VOID has been used, it is also possible and contemplated to use other words, such as COPY, DUPLICATE, or COUNTERFEIT, as long as it is evident that the document is a copy of the original.

From all that has been said, it will be clear that there has thus been shown and described herein a copy protected document which fulfills the various objects and advantages sought therefor. It will become apparent to those skilled in the art, however, that many changes, modifications, variations, and other uses and applications of the subject copy protected document are possible and contemplated. All changes, modifications, variations, and other uses and applications which do not depart from the spirit and scope of the invention are deemed to be covered by the invention, which is limited only by the claims which follow.

What is claimed is:

1. A copy protected document comprising a document having a surface for receiving printed images, a first image which indicates that a copy of the document has been made, the first image comprising a series of concentric circles radiating out from a central point. and a second image which hides the first image.

2. The copy protected document of claim 1 wherein the series of concentric circles are formed of a series of thin lines.

3. The copy protected document of claim 2 wherein the lines have a rule weight of 0.1 point.

4. The copy protected document of claim 1 wherein the circles increase in size as the circles radiate out from the central point.

5. The copy protected document of claim 1 wherein the circles increase in size at a rate of 0.02 inches per circle.

6. The copy protected document of claim 1 wherein a copy of the document exposes the first image with the first image interfering with the second image.

7. The copy protected document of claim 1 wherein a copy of the document exposes the first image independent of the angle at which the copy is made.

8. The copy protected document of claim 1 wherein the first image has a density of screen of approximately 15%.

9. A copy protected document comprising a document having a surface for receiving printed images, a series of first images which each indicate that a copy of the document has been made, each of the first images comprising a series of concentric circles radiating out from a central point, and a second image which hides the series of first images.

10. The copy protected document of claim 9 wherein the series of concentric circles are formed of a series of thin lines.

11. The copy protected document of claim 10 wherein the lines have a rule weight of 0.1 point.

12. The copy protected document of claim 9 wherein the circles increase in size as the circles radiate out from the central point.

13. The copy protected document of claim 9 wherein the circles increase in size at a rate of 0.02 inches per circle.

14. The copy protected document of claim 9 wherein a copy of the document exposes the series of first images and the series of first images interfere with the second image.

15. The copy protected document of claim 9 wherein a copy of the document exposes all of the first images.

16. The copy protected document of claim 9 wherein a copy of the document exposes all of the first images independent of the angle at which the copy is made.

17. The copy protected document of claim 9 wherein the first images has a density screen of approximately 15%.

18. A method of making a copy protected document which has a surface for receiving printed images, the method comprising the steps of printing a first image on the surface, the first image comprising a series of concentric circles radiating out from a central point and which indicates that a copy of the document has been made, and printing a second image which hides the first image.

19. The method of claim 18 wherein the step of printing the first image further comprises the step of printing the circles in increasing size as the circles radiate from the central point.

20. The method of claim 18 wherein the step of printing the first image further comprises the step of forming the circles from a series of thin lines and each of the lines having a rule weight of 0.1 point.
